(19) United States
(12) Patent Application Publication
(10) Pub. No.: US 2009/0150355 A1
(43) Pub. Date: Jun. 11, 2009

(54) Software method for data storage and retrieval

(76) Inventors: Norton Garfinkle, New York, NY (US); Richard Garfinkle, Chicago, IL (US)

Correspondence Address: TED SABETY, c/o Sabety +associates, PLLC, 1130 Bedford Rd., PLEASANTVILLE, NY, 10570, US

(21) Appl. No.: 12/324,959

(22) Filed: Nov. 28, 2008

Related U.S. Application Data
(63) Continuation-in-part of application No. 12/007,444, filed on Jan. 10, 2008.
(60) Provisional application No. 60/990,760, filed on Nov. 28, 2007.

(51) Int. Cl. G06F 17/30

(52) U.S. Cl. 707/3; 707/100; 707/10; 707/E17.045; 707/E17.014

(57) ABSTRACT

This invention discloses a novel method for storing data in virtual multidimensional blocks and accessing and retrieving desired information from these blocks. Specific items of data whose characteristics fall within the range of a specified block are stored within that block. Blocks with smaller ranges are nested within larger blocks with the same characteristics. This invention's search method involves checking the specific range of a search query against the largest relevant block range, and then successively checking smaller and smaller range blocks that contain the desired data. This method provides greater speed and accuracy than conventional database linear storage and record by record search methods.

This application claims priority to U.S. Patent Application No. 60/990,760, filed on Nov. 28, 2007, which is incorporated herein by reference for all that it teaches. This application is a continuation in part of U.S. patent application Ser. No. 12/007,444, filed Jan. 10, 2008, which is incorporated herein by reference for all that it teaches.

### BACKGROUND AND SUMMARY OF THE INVENTION

Standard database methodology consists of having each item of stored data associated with a designated set of characteristics. Each characteristic is assigned specific values for each piece of data. Each item of data is usually referred to as a “record” and the characteristics are called the “fields” of that record. Searches of such databases are typically done by specifying desired values or ranges of values for a plurality of such fields. Each individual record in the database is then checked against the specified values and those records that fit the requested values are identified and retrieved as successful results of the search. Since each record in the database needs to be checked, such a search can be slow and demanding of substantial computing resources if the database is large. Various intelligent search methods have been employed to try to speed this up, but the fundamental difficulty lies in the system of storing and examining and accessing each individual record in the database. What is needed is a storage and retrieval method that does not require the examination of each individual record in the database.

There have been several attempts at such new methods (Rustige, Aldred, and Fujihara et al. cited below and incorporated herein by reference. Rustige (U.S. Pat. No. 6,134,542) addresses the problem of searching multiple databases with a single query. His method involves the creation of a separate database containing references to characteristics of the records of these databases. His references are keyed by specific values for those characteristics not ranges. Aldred (U.S. Pat. No. 6,236,988) uses a branching tree structure to organize some of the data in a database. This structure creates a hierarchy of objects and a table for finding particular objects. This allows for faster retrieval of an object and its descendants, but still uses fixed value searching not range searching. Fujihara (U.S. Pat. No. 6,687,688) discloses a method using multi-dimensional coordinate data. The method therein uses labels based on coordinate data to access and retrieve desired data. This method still requires a record by record search of the whole database for matching query characteristics to the labels.

This invention discloses a storage method that stores data in blocks, representing all the values that fall within specified ranges for specified characteristics. The data items can be locally entered, obtained from preexisting individual data sources such as local databases, or drawn from a wider internet search. The data entries may be entered directly from these sources or data items calculated from them may be entered. All data items are predesignated as members of each relevant dataspace block. These designations can be created automatically by examination of each data item upon first entry into the database or at any subsequent time when new classifications are established or when data values are changed within a given data item.

When a search is conducted the range of the search query is automatically compared in turn with the ranges of each relevant preestablished block's metadata. If the search range contains the relevant metadata block ranges, the software pulls out all the data items in the relevant block avoiding the task of checking each individual data item within the block. If the search range overlaps the block range, the software then uses the same search procedure to check subblocks contained in that block and then identifies only the data items in that subblock that match the query. If the search query has a further specification, then the relatively small number of individual items of the last delineated block or subblock can be examined using conventional data analysis methods to extract the data items that fit the specific characteristics of the query.

While this last part of the search would commonly use conventional record by record search methods, these methods would be used on a much more restricted dataset than a full scale conventional search of every single record in a complete database. Thus the dataspace method saves search time and computer power.

Another preferred embodiment is as a data sorting front end on a search system such as an internet search engine. In this embodiment the data would be generated by a search and then sorted into dataspace blocks for ease of further search and/or analysis.

A further embodiment of this invention is the operation of a method that uses the inventor to execute the sorting and classification of data extracted from single or multiple sources into blocks that can in turn be more easily searched. The sources for extraction can be results of calculations or found contents on a single computer, a local or wide network or the entire internet.

Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

### BRIEF DESCRIPTION OF DRAWINGS

FIG. 1: This is a three dimensional abstraction of a typical dataspace.

FIG. 2: This is a flowchart of the basic dataspace search procedure.

### PRIOR ART

The literature contains several approaches to data organization in a computer system. For example, those listed below:

| | | |
|---|---|---|
| 6,134,542 | October 2000 | Rustige |
| 6,236,988 | May 2001 | Aldred |
| 6,687,688 | February 2004 | Fujihara, et al. |
| 6,745,115 | June 2004 | Chen, et al. |
| 7,020,651 | March 2006 | Ripley |
| 20030126145 | July 2003 | Sundstrom, Bengt; et al. |
| 20030204537 | October 2003 | Liang, Lily L.; et al. |
| 20040036716 | February 2004 | Jordahl, Jena J. |
| 20060136380 | June 2006 | Purcell; Terence Patrick |
| 20060161579 | July 2006 | Venguerov; Mark |
| 6,405,207 | Petculescu, et al. | Jun. 11, 2002 |
| 6,505,205 | Kothuri, et al. | Jan. 7, 2003 |
| 6,330,572 | Sitka | Dec. 11, 2001 |
| 6,714,979 | Brandt, et al. | Mar. 30, 2004 |

Several of these attempt data organizations that provide improved storage and searching characteristics, but are nonetheless distinct from the present invention. In particular:

| | | |
|---|---|---|
| 6,405,207 | Petculescu, et al. | Jun. 11, 2002 |

Petculescu's patent is a filtration process to remove extraneous results from Database queries and from the remaining query answers to produce aggregate data (such as median home price from a list of prices). It's search method is based on recursive tree structures, but these are used as filter mechanisms. The data themselves are not block organized as in the current invention.

| | | |
|---|---|---|
| 6,505,205 | Kothuri, et al. | Jan. 7, 2003 |

Kothuri's invention concerns a better than standard organizational method for storing individual data records. It uses a branching tree process whose end nodes are individual records. Kothuri's sorting process produces indices for data stored in other databases. It employs the characteristic data of each individual data record to determine which branch to place the data on. It then continues down the branches creating new branches as needed until it reaches one with few enough data entries to satisfy its preset requirements. However, Kothuri's method treats multidimensional data as needing sorting by one dimension at a time. It breaks up lists of data records according to a single dimension producing subnodes and then divides those nodes according to a single dimension and so on. The block structure of the current invention permits blocks to be broken up in multiple dimensions simultaneously. Furthermore, Kothuri's invention presupposes that there is a single criterion for subdivision: number of elements in each record list. It cannot accommodate the possibility of division into blocks for other purposes and by other algorithms simultaneously. Nor can it handle precreated blocks used to sort data yet to be entered or to resort records whose values change.

| | | |
|---|---|---|
| 6,330,572 | Sitka | Dec. 11, 2001 |

Sitka's invention involves the use of sorting criteria to ensure that data files (specifically image files) sharing certain characteristics in common are stored in the same physical storage medium (the same hard drive for example). Sitka's invention expands the criteria that a standard Hierarchical File Management System would use to decide where to physically store a particular file. Sitka's invention is a process that checks a file when it is saved and decides which physical data storage device to place it on. It facilitates search in a simple fashion making sure that files likely to be retrieved together are physically stored near to each other. It is narrow in purpose and does not imply or foresee any of the software data storage or flexibility of the current invention.

| | | |
|---|---|---|
| 6,714,979 | Brandt, et al. | Mar. 30, 2004 |

Brandt's invention involves the use of multiple data tables with specific characteristics of phone calls to determine whether individual phone calls need to be added to call records dispatched daily to specific customers who need daily phone log information as opposed to the more standard monthly records. Brandt's method is a data sorting process using a set of tests. It is not itself a data classification or storage method, rather it is a narrowly focused filtration process designed to solve a single problem for phone companies.

### DETAILED DESCRIPTION OF THE PREFERRED EMBODIMENTS

The first preferred embodiment of this invention is a dataspace management software program on a computer or other microprocessor device that combines the capability of doing the same work as standard relational database management programs with added capability described in this invention.

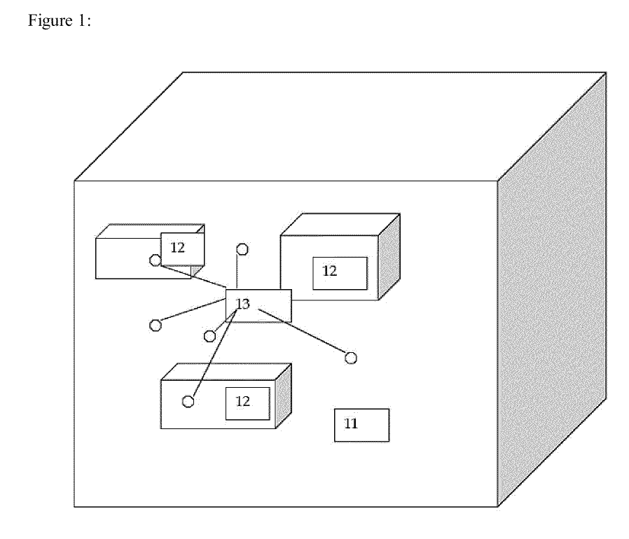

### Referring to FIG. 1:

The large block (11) represents a dataspace block, the smaller blocks (12), are subblocks inside it. The circles (13) stand for individual pieces of data.

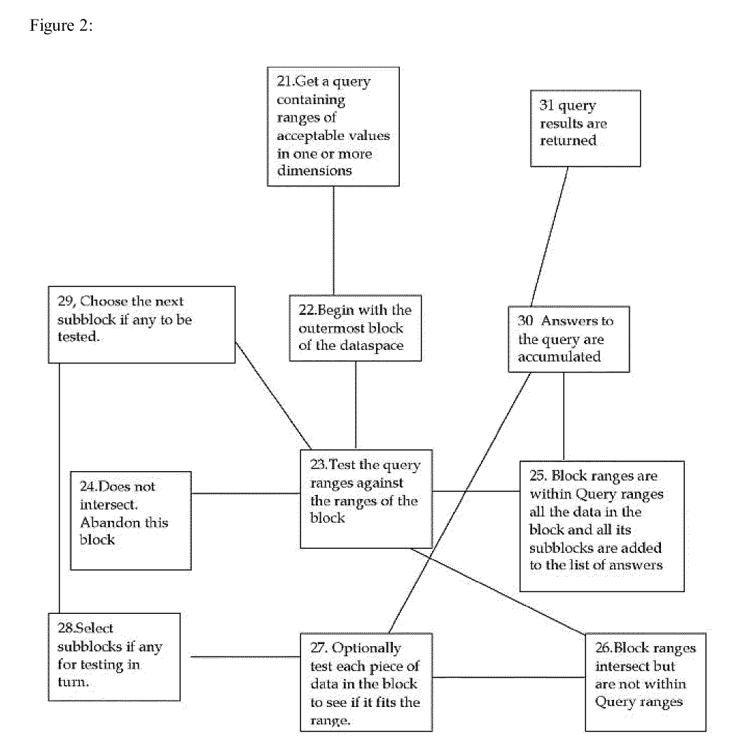

### Referring to FIG. 2:

21. a query is created containing desired ranges of values for the searched data.

22. the largest block of the entire dataspace is selected.

23. the current block's metadata is compared to the query range to determine whether the block's metadata fits the query.

24. If the block's ranges do not intersect the query's ranges, that block is abandoned. Neither it nor its subblocks will be checked again in this query.

25. If the block's ranges lie within the query's ranges, then all the data contained in the block and its subblocks will be added to the store of accumulated answers.

26. If the block's ranges and the query's ranges intersect, then the block's contents must be checked.

27. The individual data elements of an intersecting block can be optionally checked against the ranges. This procedure which is the standard one for relational databases only occurs optionally and only under this specific narrow circumstance as opposed to happening in each case for each data element. Only the data stored in the block itself not in its subblocks are checked at this point. Any successfully checked data are added to the store.

28. The subblocks of the present block are selected one at a time, going through the block's list of subblocks in sequence.

29. Once a block is picked it is fed back into the search procedure.

30. Answers accumulate into a query response.

31. Once the last block has been checked the accumulated responses are returned to the query source as is standard in database usage.

A dataspace management software system for a pharmaceutical company is an example of this preferred embodiment. The need for continual and frequent access to and analysis of the data in the pharmaceutical company database substantiates the need for a system that provides fast access to data and an easy ability to update.

The pharmaceutical company's dataspace management system addresses the need to acquire, store, retrieve and access information on each medical condition and each drug of interest to the company. We can call this content the company's drug dataspace.

The drug dataspace would consist of all the dimensions needed to describe a drug, including its use for specific medical ailments, its patent situation, its competitors and their patent position as well as other relevant data. Some dimensions would apply to any manufactured product, including, for example: manufacture cost per unit, recommended sales price, total sales volume, average yearly sales volume, current and potential demand for the drug. Drug-specific ranges might include date of patent, groupings of conditions the drug can treat, groupings of side effects. For example, all drugs that are used for heart conditions or that have heart side effects would be identified as in the Coronary Range; within that range would be subranges for the various kinds of coronary effects possible (for example, a drug to treat arrhythmia would be in the arrhythmia subrange for Treated Conditions. A drug that had the side effect of causing arrhythmia would be in the same subrange in the Side Effect dimension). Within these subranges would be efficacy and side effect risk ranges. A drug with a 95% efficacy against Arrhythmia would be in a 90-100% efficacy subrange within the Arrhythmia Subrange within the Coronary Range of the Treatment Dimension. One with a 22% chance of causing Arrhythmia would be in the 20-30% risk category within the Arrhythmia Subrange within the Coronary Range of the Side Effect Dimension.

In this embodiment we can trace the path of a query for 95% efficacy arrhythmia drugs with no more than 2% risk of side effect.

FIG. 2 which describes the central search routines of this invention applies directly to this preferred embodiment.

Referring to FIG. 2, the search begins with the creation of a query that specifies the ranges of acceptable data items: Treated Conditions: Arrhythmia; Efficacy: 95-100%; Side Effect Risk 0-2%.

The outermost block of the dataspace is selected for analysis. Its ranges are checked against the above query.

Since this outermost block does indeed have dimensions for Treated Conditions, Efficacy, and Side Effect Risk, they are then checked. The outermost block's ranges would be Treated Conditions: All; Efficacy: 0-100%; Side Effect Risk: 0-100%. So the block's ranges intersect but are not contained within the ranges of the query.

The subblocks of this block would then be checked. Those subblocks would be organized mostly by Treated Conditions, so the Coronary Block, Efficacy: 0-100%, Side Effect Risk: 0-100% would be the only subblock of the outermost block selected for further checking. This subblock would be divided into a plurality of additional subblocks: among them would be those that had Treated Condition: Arrhythmia; Efficacy: 90-100%; Side Effect Risk 0-5%. None of the other subblocks would meet the criteria so the search would address this subblock and only this subblock.

This subblock's ranges do not fit the query criteria exactly. Its Efficacy Range and its Side Effect Risk Range are still too broad. The individual data item contents of this subblock would then be checked using a conventional item by item analysis. Those that had Efficacy of 95%-100% and side effect risk of 0%-2% would be identified as successful results. These successful results would be sent back as query answers.

Utilizing this rapid procedure the following blocks and subblocks had their metadata checked:

Outermost Block.

Subblocks of that based on Condition.

Subblocks of the Coronary Block based on Condition, Efficacy, and Side Effect.

Only one of all these subblocks (the one with: Condition: Arrhythmia; Efficacy: 90-100%; Side Effect Risk 0-5%) would have been checked item by item for exact query matches.

The dataspace dimensions and data item information are not permanently fixed. When new data, or a new dimension or new subrange is added, the dataspace can rapidly reconfigure itself.

The company would, in the normal course, have other data maintenance areas of interest. The company could choose to incorporate the data related to all of its areas of interest into a single overarching dataspace in order to facilitate queries that relate to more than one broad area, or have dataspaces covering separate areas because smaller spaces make for faster searches since there are fewer blocks to check.

A second preferred embodiment consists of embedding the dataspace software routines of this invention in software systems that are used to manage specific content areas: for example, a preexisting general purpose weather service program. The dataspace system could be applied by dividing the world into regions and subregions as dataspace blocks using longitude and latitude as range dimensions. This dataspace would serve as storage of information for weather modeling and be used for weather prediction and calculation as opposed to database querying.

In the above preferred embodiments a dataspace block is a data structure containing at least the following three components:

1. A list of data entries (possibly empty).

2. A list of subblocks (possibly empty).

3. Metadata consisting of a list of ranges. Each range is associated with a specific characteristic of the data entries, and specifies what range values each data entry can have for that characteristic in order to qualify to be in that block.

A data element that is a member of the data list in a block or a data list in any of that block's subblocks is said to be “inside” that block. Similarly a block that belongs to the subblock list of a block or a subblock list of any of its subblocks is said to be “inside” that block.

Because the subblocks of a block are themselves dataspace blocks they can in turn contain their own subblocks. Thus a block hierarchy is created. Note: a single block can be a subblock of more than one block thus the hierarchy structure need not be a simple tree diagram. Each standard dataspace has one or more top blocks.

The Metadata of each block is a list of ranges. Each range is associated with a characteristic of the data entries. Characteristics can be the equivalent of fields in a standard relational database, they can also be XML Elements or Attributes, they can be calculated values (such as the sum of two other characteristics or the width of an image), or any other unit of information computationally discernable from the data entry. The range specifies what values of the characteristic can be found for the data entries inside the block. The important theoretical concept is that any kind of data that can be given an ordering of any kind can be used as a characteristic for ranges.

The simplest kind of range is numeric. This would be used for characteristics that have a useful number value. For example, in a dataspace of weather data, temperature would be such a characteristic. A Block might have a temperature range of 0-50 degrees in its metadata and it might contain subblocks that divide up this temperature range: one subblock having a range of 0-10, another 10-20, another 20-30, another 30-40, and the last 40-50.

The next simplest kind of range is lexical where the characteristic represents a string of characters. Lexical ranges would commonly be alphabetic in ordering although other kinds of order could be programmed in instead. A dictionary could be made using such an alphabetic dataspace. In such a case the data entries would have ‘Word’ as one of their characteristics. One block might have ‘B’ as its lexical and it would match any word whose first letter is ‘B’. This block might have ‘Ba-Bd’ as a subblock and ‘Be-Bh’ as another and so on.

Another kind of range would be a disjunctive list range. A data entry would belong to this characteristic if the appropriate characteristic contained any word on the list. For example, in a dataspace whose entries were web pages on economic subject matter, one might make a range for the body of the page using a wordlist containing ‘tax’, ‘revenue’, ‘spending’ and other such words. Any web page that had any of those words would belong to the block. In this case, subblocks would have smaller lists in the ranges than the block that contains them.

One could also have a conjunctive list range in which a data entry would have to match all the words in the list rather than any of them. In this case subblocks have longer lists in their ranges (for example a block with a range list of ‘tax’ could have a subblock with a list of ‘tax’, ‘income’, and ‘federal’).

The above two kinds of blocks are very useful in dataspaces that serve to hold the results of web searches.

A range can have the value: ALL. An all range contains any entry. Ranges can also be ALL below or ALL above. So a numerical range that goes from ALL to 30 could be any number less than 30, and one that goes from 5.6 to ALL would fit any number greater than 5.6.

This should show that any kind of data that can be extracted and used in comparisons can serve as the characteristic and values of a range.

The metadata of a block typically has one range for each characteristic used in the dataspace. For example, the metadata for blocks in a weather dataspace could have a temperature range, a maximum wind speed range, a precipitation range, (all of these would be numeric), a region range (that would be a disjunctive list for what states the block covered) and possibly others.

Metadata in blocks can be created in several ways.

1. The metadata can be pre-set before data is entered. For example, if a scientific test needs to classify outcomes based on specific groupings then the ranges for those outcomes would be precoded into blocks and then the data sorted into appropriate blocks. The standard sorting procedure is to check the top block and see if the data fits in that block. If it does then each subblock is checked to see if it fits there. This process continues recursively until the lowest block or blocks the ranges of which contain the characteristic values of the data entry are found. The data entry is then placed in the data lists of any such lowest blocks.

2. The metadata can be calculated based on the data. For example, if one wanted to create blocks representing the statistical results of a study, one might calculate the mean and standard deviation using ordinary statistical methods and then create blocks representing, 1 standard deviation from the mean, 2 standard deviations, etc. The data could then be sorted into the blocks using the method above.

3. The metadata can be generated by partitioning a previously created block into subblocks. In this case one might want to divide up an overly large block into easier to search subblocks by dividing up one or more of the ranges in the block's metadata to create the metadata in the subblocks. The process of partitioning involves making new blocks with the broken up ranges then adding them to the block list of the block being partitioned, then redistributing the data list of the block into these new subblocks. For example, in a phone book dataspace containing the phone numbers and addresses for everyone in New York State, one might start out with a county by county dataspace. Counties of small population would not need subdivision since they are small enough for easy search, but New York County would need to likely be broken up into smaller areas (such as 10 block zones) then any of these that had too high a population could in turn be broken up into single block zones.

The process whereby characteristics of particular data entries are determined (from which it is determined which block the data belongs to) depends on the format of the data. If the data are in the form of relational database records then standard querying can find any desired field's value. Similarly if the data are in the form of XML documents, then standard tree-node search processes can be used to get the value of any element or attribute. In a standard computing environment anything stored as a data structure or object in an object oriented programming language can have its components queried using standard methods in those languages. For other less easily accessed kinds of data, more sophisticated methods might be necessary (for example, extracting information from sound and image files can be done using the sophisticated processes of those specialized areas of programming). All that is necessary in any of these cases is to program the data extraction method into the dataspace so it can access the information it needs to determine the values of each characteristic. If the process of determining the data characteristics is costly in time and/or processing power, the data entry may retain the characteristic values in memory for faster comparison during queries.

Adding a new data entry to the data space works a follows:

the first step is to determined its characteristics as discussed above. One of two distinct procedures can be used to add the data entry to the dataspace depending on whether one has a specific block destination in mind for the new data or whether one simply seeks to place it in any block that it would fit in. The first is followed if one wishes to place the data into a prechosen block, the second if one wishes to find those blocks in the dataspace that the data entry would fit inside.

Case 1. The data entry is simply added to the data list of the block, then the data entry's characteristics are compared to the ranges of the block's metadata. If the data entry's characteristics fall outside the range then the range can be expanded to include the new characteristics. If the ranges of a block have been expanded the ranges of any blocks containing that block will also be checked to see if they have to expand to fit the new ranges. If the containing block's ranges change, any blocks containing it can then also be changed to fit if necessary and so on up the hierarchy. For example, in a dataspace of the population of regions, it may be desired to have fixed blocks for each region, but to have characteristics such as age and income ranges in the metadata of those blocks. If a new person moved into a town the data entry for that person would be added to the block representing the town. That person's age and income would be compared to the age and income ranges for the town's block. If the age range had been 0-85 and the income range $0.00-$200,000.00 and this person was 93 years old and made $1,500,000.00 per year the ranges on the block would change to 0-93 for age and $0.0-$1,500,000.00 for income. The block for the state containing the block for the town would then be checked against these new ranges to see if they need to be expanded. Note: if adding a number of data entries in this way, it can be of computational advantage to defer expansion of the ranges until all of the data entries have been added. In this case, the data entries are added and then the entire new data list is swept through to determine the block's ranges, only after this would the ranges for containing blocks be redetermined.

Case 2. In this case a quick search is conducted to find the lowest block or blocks (that is the block or blocks farthest along in the hierarchy) that this data entry belongs in. The procedure is similar to that of a query. Top block is selected, its subblock list is checked one block at a time to see if the data entry fits inside the metadata of that block (that is if its characteristics lie within all the ranges of the block's metadata). If it does not fit into any of the subblocks, the data entry is placed in the top block. If it fits in to a block that block's subblocks are themselves checked to see if it fits into them. The data entry is added to the data lists of any blocks that contain the data entry but do not have any subblocks that contain the data entry.

Similar processes to the above can be employed if a new block needs to be added to the dataspace.

If it is necessary to add a new subblock to those subblocks contained in a predetermined block (such as adding a town's block to the subblocks of a state's block) then a process like Case 1 above is followed: The new subblock is added to the subblock list of the old block and the ranges of the old block are expanded if necessary to fit the ranges of the new block. If a set of blocks are being added this expansion can be deferred until all have been added. After the block's metadata has been recalculated any blocks containing that block can also be expanded if necessary and so on up the hierarchy.

If the new block simply needs to find its place in the hierarchy then a process similar to but more complicated than case 2 can be followed. In this case blocks are checked to see not only if they contain the new block completely, but, if they are contained in the new block. The testing is as follows.

If the new block contains the old block then the old block is removed from the block list of the block it belongs to and is added to the block list of the new block.

If the old block contains the new block then the new block is checked against the subblocks of that new block to see if it is contained within any of them or contains any of them. If no subblock of the old block contains the new block then the new block is added to the subblock list of the old block. If a subblock of the old block does contain the new block then this procedure is carried out again using this subblock as the old block.

For example, suppose one had a dataspace that had blocks for the countries of the world and within those blocks, subblocks for all the major cities. If one later on decided that it would be good to add regions of the countries as an intermediate block level then a set of new subblocks would need to be added. In the original form of the dataspace, the blocks for Seattle and Tacoma would be sub blocks of the block for the United States, when the new regional blocks were added, the block for Washington State would be found to be a subblock of the United States, but it would also be found that Seattle and Tacoma lay within the block for Washington State. These two subblocks would be removed from the block list of the United States and added to the block list of Washington State which would in turn be added to the block list for the United States.

The dataspace system is superior to standard relational databases in that it provides faster determination of which data entries fit a query. The faster access comes from the ability to test the metadata of a block quickly against the query of the search. The test uses the ranges of the metadata and sees whether the ranges specified in the query are disjoint from those ranges, contain those ranges, or intersect those ranges. A block whose ranges are disjoint will contain no data entries that fit the query. A block whose ranges are contained within the ranges of the query has all its data entries (and the data entries of all its subblocks) fitting the terms of a query. A block whose ranges intersect but are not fully contained in the ranges of the query needs to have its subblocks checked against the query and then have its individual data entries tested against the query by examining the specific content of each data entry. Because this is the only circumstance in which individual entries are examined in a dataspace query the number of individual data item tests is minimized. This is a great reduction in number and complexity of tests compared to standard record by record database query methods.

Dataspaces are also easy to update since whenever a new data entry is added each block it will belong to can be determined by identifying and specifying the relevant data characteristics of the entry. They can then be tested against the blocks in the hierarchy to find the appropriate blocks for the new data entry.

It is also possible to introduce new characteristics and to change the metadata of one or more pre-established blocks by adding, removing, or modifying the ranges. Added ranges could involve the addition of previously unexamined characteristics. In this circumstance the data entries would be automatically examined, specified, and distributed through the newly reformed block hierarchy.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention. Modifications of the above disclosed apparatus and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

What is claimed:

1. A method for storing and accessing related data comprising:
Storing in a computer memory device data organized in at least one identifiable dataspace block, each of said blocks further comprised of, metadata representing a range of predetermined characteristics.

2. The method in claim 1 where the dataspace blocks are organized in a hierarchy where at least one larger dataspace block is comprised of reference to at least one dataspace subblock, where the metadata of the subblock represents a range of a predetermined characteristic that is less than the range of the same characteristic in the larger dataspace block as indicated by the metatdata associated with the larger dataspace block.

3. The method of claim 1 further comprising combining two datablocks into one datablock by combining the ranges associated with the two datablocks into one range, said combined range being stored in the one surviving datablock.

4. The method of claim 1 further comprising dividing one dataspace block into two dataspace blocks by separating the one predetermined range into two distinct predetermined ranges, each of such two distinct predetermined ranges being stored in the two respective separated dataspace blocks.

5. A method of searching a dataspace organized as a hierarchy of at least one dataspace blocks, for a dataspace block encompassing a predetermined search value associated with a predetermined characteristic comprising:
determining a dataspace block comprised of metadata further comprised of a range of the characteristic where the predetermined search value falls within the range.

6. The method of claim 1 further comprising converting a database organized as a relational database into a database organized as a hierarchy of at least one dataspace blocks.

7. The method of claim 1 further comprising storing in a relational database record a reference to a dataspace block.

8. The method of claim 1 further comprising storing in a database organized as a hierarchy of at least one dataspace blocks, at least one relational database record within at least one corresponding dataspace block.

9. The method of claim 5 further comprising using a single query to search a database whose organization is a combination of a relational database and a database organized as a hierarchy of datablocks.

10. The method of claim 5 further comprising obtaining the data placed in the database organized as a hierarchy of datablocks by calculating which datablock contains metadata encompassing the predetermined search value.

11. The method of claim 5 further comprising obtaining the data placed in the database organized as a hierarchy of datablocks by comparing the endpoints of the predetermined range of at least one datablock with the predetermined search value.

12. The method of claim 5 further comprising, receiving from a remote computer connected to a central set of at least one computer executing the method, the predetermined search value and transmitting to said remote computer at least one data value recovered from a datablock comprising metadata further comprising a range, where the search value lies within the range.

13. The method of claim 1 where the range is specified as a numerical range.

14. The method of claim 1 where the range is specified as a lexicographic range.
